(19) United States
(12) Patent Application Publication
(10) Pub. No.: US 2008/0270415 A1
(43) Pub. Date: Oct. 30, 2008

(54) Providing an incentive for including an item in content

(76) Inventors: Ehud Chatow, Palo Alto, CA (US); Andrew Fitzhugh, Palo Alto, CA (US); Steven Teddy Rosenberg, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/796,216

(22) Filed: Apr. 27, 2007

(51) Int. Cl. G06F 17/30

(52) U.S. Cl. 707/10

(57) ABSTRACT

Providing an incentive for including an item in content. The content is accessed and received from a first party. The content is searched for at least one item identified by a second party. The second party is notified in response to identifying the item in content. A mechanism is provided whereby the second party provides an incentive to the first party for including the item in the content.

### BACKGROUND

Digitized information has allowed a rapid dissemination of information and content to a large global population. Many times an author of content is unaware of the broader global interest their content might have beyond their intended use. Their content may contain items that are of interest to a broader audience than they are aware.

Many items of interest contained in content are digitized for the purpose of submitting for printing and reproduction, or for the purpose of documenting an event, opinion, or discovery. Such items of interest can be as broad and varied as the demographics around the globe.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram illustrating a system for interconnecting communities of content providers, service providers, and user of items of interest, upon which embodiments of the present invention can be practiced.

FIG. 2 is a block diagram illustrating a system for providing an incentive for including an item in content, in accordance with an embodiment of the present invention.

FIG. 3 is a block diagram of an exemplary system for interconnecting a provider of content, a service provider, a searcher of content, a user of items of interest in content, and providing an incentive for including an item in content, in accordance with an embodiment of the present invention.

FIG. 4 is a flow chart illustrating a process for providing an incentive for including an item in content, in accordance with an embodiment of the present invention.

The drawings referred to in this description should not be understood as being drawn to scale except if specifically noted.

### DESCRIPTION OF EMBODIMENTS

Various embodiments of the present invention, providing an incentive for including an item in content, are described herein. In one embodiment, a method is described for providing an incentive for including an item in content. The content is accessed and received from a first party. The content is searched for at least one item identified by a second party. The second party is notified in response to identifying the item in content. A mechanism is provided whereby the second party provides an incentive to the first party for including the item in the content.

Reference will now be made in detail to the various embodiments of the invention, examples of which are illustrated in the accompanying drawings. While the invention will be described in conjunction with the various embodiments, it will be understood that they are not intended to limit the invention to these embodiments. On the contrary, embodiments of the invention are intended to cover alternatives, modifications and equivalents, which may be included within the spirit and scope of the invention as defined by the appended claims. Furthermore, in the following description of the various embodiments of the present invention, numerous specific details are set forth in order to provide a thorough understanding of embodiments of the present invention. In other instances, well known methods, procedures, and components have not been described in detail as not to unnecessarily obscure aspects of the embodiments of the present invention.

Items of interest that are generated without ulterior motives beyond reproduction or documentation of content can give a perception of validity and sincerity. If a product or brand name is mentioned superfluously in such content, the regard that the author gives to such a product or brand name is typically seen with higher credulity than if the product or brand name were presented in an advertisement.

Embodiments of the present invention provide an incentive for an author to include items of interest in content they generate. By providing an incentive, an author of content can be motivated to provide more items of interest in their content. In various embodiments, the form of the incentive can be groomed towards the interests of the content provider. For example, if the content provider is interested in printing or publishing their content, a discount to offset the cost of printing can be offered as an incentive. The content provider may be motivated to include more references to the item of interest, or present the item of interest in a larger or more accentuating photograph. An incentive such as a reduction in printing or publishing cost may also allow broader distribution of the content containing the item of interest by reducing the cost of the printed content and thusly allowing broader distribution of the item of interest.

Embodiments of the present invention can be used to the benefit of a second party who submits items of interest for searching in the content. By motivating the content provider the second party can cause his item of interest to have broader and possibly better exposure to the public at large. Embodiments of the present invention provide a mechanism for a second provider to offer an incentive to the content provider.

Embodiments of the present invention provide a second party with a search mechanism that receives their item of interest, verifies that their item of interest is found in content and notifies the second party that their item of interest has been identified in a provider's content.

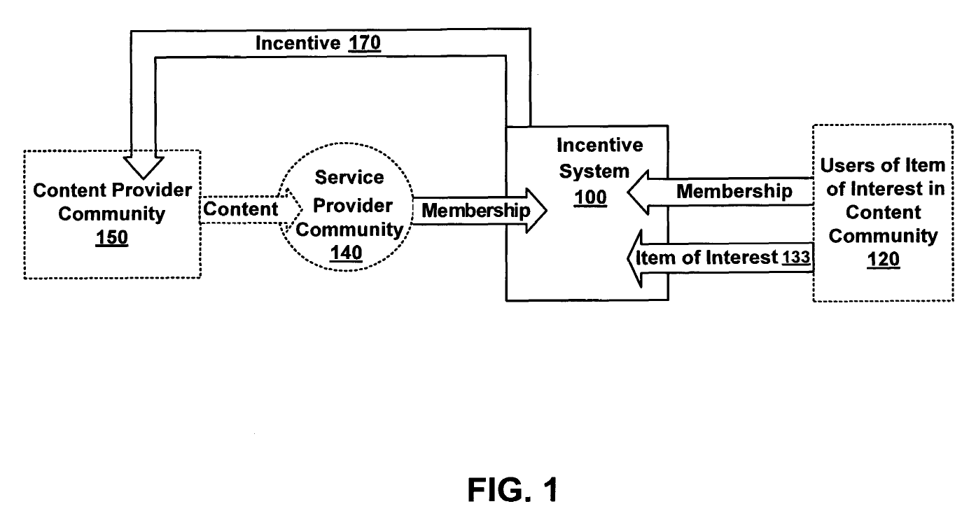

With reference to FIG. 1, a block diagram illustrating a system for interconnecting communities of content providers, service providers, and users of items of interest in content, is presented upon which embodiments of the present invention can be practiced. Content provider community 150 generates a plethora of content with a wide and varied array of subject matter. The motivation for generating such content is as varied as the content. For example, content can be generated in a range of topics, from evaluating computer operating systems to publishing a cookbook. Most likely items such as a computer manufacturer or the brand name of a cooking utensil will be incorporated into the content, as text and/or an image. These items may be mentioned superfluously in the content. However, these items unbeknown to the particular content provider may be an item of interest to users of item of interest community (UIICC) 120.

Content provider community 150 interacts with service provider community 140 in the course of generating content. For example, the content provider writing a blog or responding to a question in an open forum is putting their content on the Internet. Another example is the content provider who contributes to their school's PTA cookbook is putting their content in a printer's data base. Service provider 140 comprises a repository of content from content provider community 150.

Disconnected from content provider community 150 is UIICC 120. UIICC 120 is interested in presenting their product to the public in a manner that is credible and has integrity. Advertising is an obvious approach, but advertising by UIICC 120 can often be met with skepticism and incredulity.

In accordance with an embodiment of the present invention, incentive system 100 fulfills the desire of UIICC 120 to give their product a perception of credibility and sincerity. Incentive system 100 comprises a system for compensating content provider community 150 for including in their content item of interest 133. As a member of incentive system 100, UIICC 120 submits item of interest 133 to incentive system 100. As a member of incentive system 100, service provider community 140 opens the repository of content, which has been deposited by content provider community 150, for searching by incentive system 100 for item of interest 133. If item of interest 133 is identified in content from a content provider, incentive system 100 notifies UIICC 120. Through incentive system 100, UIICC 120 is provided a means to compensate with incentive 170 the content provider that has been identified for generating item of interest 133 within content.

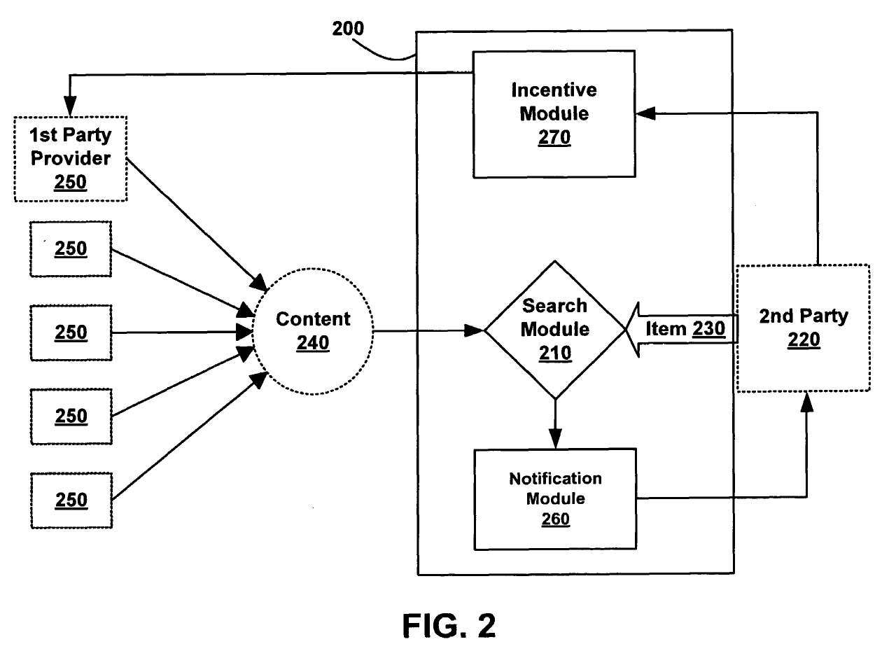

FIG. 2 is a block diagram illustrating a system 200 for providing an incentive for including an item in content, in accordance with an embodiment of the present invention. System 200 includes search module 210, notification module 260, and incentive module 270. It should be appreciated that system 200 can be implemented as software, hardware, firmware, or any combination thereof. Moreover, it should be appreciated that system 200 may include additional components that are not shown so as to not unnecessarily obscure aspects of the embodiments of the present invention.

In one embodiment, second party 220 is an entity with a need to present a product or service to the public, e.g. advertiser, manufacturer, service provider, organization, etc. Item 230 is an item of interest to second party 220 that is submitted to search module 210. Item 230 can be as varied as the demographics of second party 220. Item 230 can be in the form of textual data, image data, or printed material. For example, item 230 can be an organizational name; a brand or product name; a logo; an image of an item, place or event; or a name of a person, place, or thing. These examples of item 230 are not intended to be an all-inclusive listing but are only presented as examples. The embodiment of the present invention is not limited by the scope of item 230 and what imbues item 230 as an item of interest to second party 220.

Search module 210 receives content 240 from at least one first party provider 250 and searches content 240 for item 230 which second party 220 has provided. Content 240 is comprised of the collective content from at least one first party provider 250.

Content 240 containing items of interest such as item 230 is generated by first party provider 250 in the pursuit of activities pertinent to first party provider 250 but no necessarily related to activities of second party 220. Activities that first party provider 250 might be engaged in during the generation of items of interest are for example: writing about a personal experience or event such as a vacation or journey; or writing a procedural document such as a recipe, repair instruction, or how to do a hobby or craft. Other examples of activities that may generate items of interest are: photographing an event; video recording an activity; or creating an animation. Content 240 can be made available to search module 210 through activities such as, submitting text and/or image document for printing; posting a blog on the Internet; or submitting a video to a video viewing website.

In accordance with an embodiment of the present invention, search module 210 may poll content 240 for identifying item 230 or it may receive content 240 for identifying item 230. Search module 210 may connect to a source of content such as content 240 and look for item 230. Search module 210 can be active in its search for item 230. Search module 210 may also passively receive item 230 from content 240. Content 240 may submit items of interest that potentially contain item 230 to search module 210.

In accordance with an embodiment of the present invention, search module 240 may search for text data and/or image data contained in item 230. There are several known algorithms and techniques known to those skilled in the art for searching text data and image data and recognizing predetermined text or image data such as contained in item 230. An example of item 230 requiring search module 240 to search for text data and/or image data is an item of interest in which item 230 contains a company name and a company logo. Search module 240 will identify content containing the company's name as well as content containing the company's logo. Another example of item 230 requiring a search for either text data and/or image data is content possibly containing the name of an item of interest and/or a picture of the item of interest.

In one embodiment, an evaluation of the value of the identified item 230 to second party 220 is made within search module 210 as well as the validity of identified item 230 within content 240. Search module 210 also analyzes the validity of first party provider 250. The validation of identified item 230 and the validity of first party provider 250 can be accomplished by several metrics known in the art such as, interrogating the number of hits on a blog or URL, or analyzing the syntax in textual data.

In one embodiment, first party provider 250 comprises a computer user who generates content 240. First party provider 250 may compile content from a variety of individuals or entities. In general, first party provider 250 can be anyone who generates information, for example, a user who writes a blog regarding a hobby or a vacation; submits a text or image for printing; posts a video on the internet for en masse viewing.

In accordance with an embodiment of the present invention, notification module 260 notifies second party 220 when search module 210 has identified an item of interest that matches item 230. Notification module 260 presents to second party 220 the value of the identified item of interest as well as the validity and contact information for first party provider 250.

In accordance with an embodiment of the present invention, incentive module 270 allows second party 220 to provide first party provider 250 with an incentive for including item 230 in content 240. The incentive provided by second party 220 can have various forms. One such form can be remuneration, which in itself can have various forms such as, a discount for a service such as printing content 240, credits redeemable for the purchase of item 230, or royalties paid to first party provider 250 for the use of content 240. Other examples of possible incentives provided by second party 220 to first party provider 250 are a new or broader venue for content 240, advertisement for first party provider 250 and/or content 240.

Another example of an incentive provided by incentive module 270 is, if first party provider 250 is interested in printing or publishing content 240, a discount to offset the cost of printing can be offered as an incentive. First party provider 250 may be motivated to include more references to item 230, or present the item 230 in a larger or more accentuating photograph. An incentive such as a reduction in printing or publishing cost may also allow the broader distribution of content 240 containing item 230 by reducing the cost of the printed content and thusly allowing broader distribution of item 230.

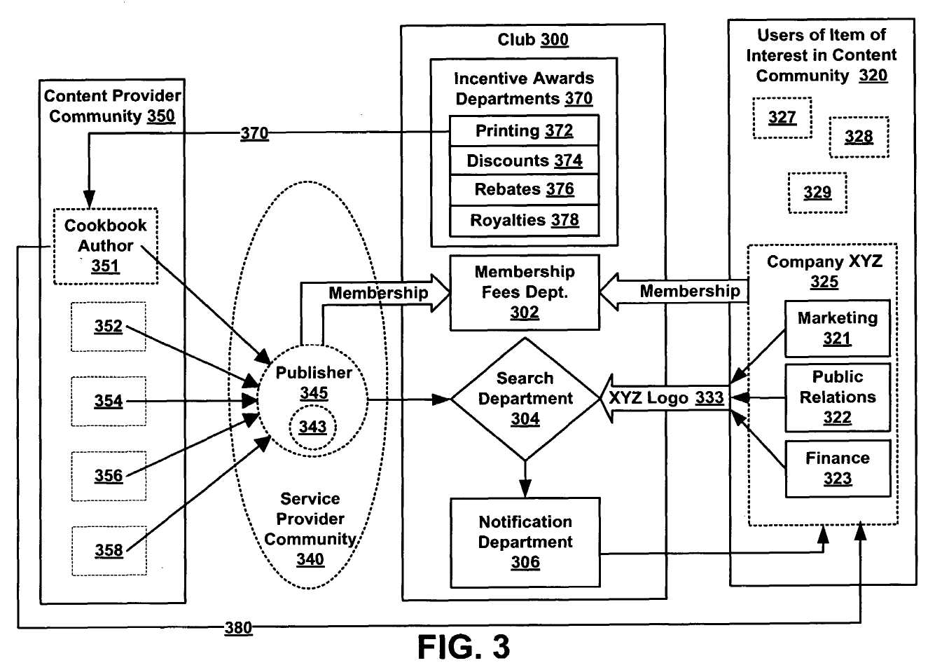

FIG. 3 is a block diagram of an exemplary system, club 300, for interconnecting a provider of content, a service provider, a searcher of content, a user of item of interest in content, and providing an incentive for including an item in content, in accordance with an embodiment of the present invention. A suitable environment for one of the embodiments of the present invention is an environment in which there is a community of content providers 350, a service provider community 340, and a users of item of interest in content community (UIICC) 320. UIICC 320 comprises many diverse companies such as company XYZ 325, and companies 327,328, and 329. Service provider community 340 also comprises many diverse service providers. For the sake of brevity and clarity, only publisher 345 is shown.

Club 300 comprises incentive awards department 370, membership fees department 302, search department 304, and notification department 306. Membership fees department 302 collects fees from participating members such as those from UIICC 320 and service provider community 340. In the present example of an embodiment of the present invention, membership fees received by membership fee department 302 help sustain club 300 and support the incentive awards granted by incentive awards department 370.

In accordance with embodiments of the present invention and the present example, company XYZ 325 has the desire to broaden the exposure of its new line of spices to the public. Company XYZ consults with its marketing department 321, public relations department 322, and finance department 323. These departments decide that the best exposure that could benefit the company's new line of spices is to have the XYZ logo appear in everyday consumer use. Their vision is to have on XYZ's website, URLs that will direct web surfers towards, images or articles of the XYZ Logo being used. As a paying member to club 300, company XYZ 325 submits as an item of interest XYZ Logo 333.

Item of interest XYZ Logo 333 is received by search department 304 of club 300. Also received by search department 304 is access to a repository 343 of content received by service provider community 340 from content provider community 350. In accordance with embodiments of the present invention and the present example, publisher 345 has been found to have content that matches company XYZ's item of interest XYZ Logo 333. Publisher 345 identifies cookbook author 351 as the content provider containing item of interest XYZ Logo 333.

In a print order for a cookbook of family recipes, cookbook author 351 has used a picture of herself dashing her lasagna with paprika from a can of company XYZ's classic spice collection. In accordance with embodiments of the present invention and the present example, image recognition software in search department 304 recognizes XYZ Logo 333 in the content from cookbook author 351. In accordance with an embodiment of the present invention, search department 304 has the option of searching publisher 345 for XYZ Logo 333 or publisher 345 may submit content they think might be useful to department 304 in their searches.

Once search department 304 of club 300 has identified XYZ Logo 333 in content from publisher 345, search department 304 determines the validity and the value of the representation of XYZ Logo 333. Criteria of value can be for example, the prominence and clarity of XYZ Logo 333 in the image; the use of XYZ Logo 333 in an appropriate manner; association of XYZ Logo 333 with a healthy life style. Validity of the content in which XYZ Logo 333 has been found can be scrutinized for example by analyzing the syntax in textual data associated with the content, or if XYZ Logo 333 had been found in blog, analyze the hits on the blog.

In accordance with an embodiment of the present invention, once the value and the validity of the content containing XYZ Logo 333 has been determined, notification department 306 notifies company XYZ that XYZ Logo 333 has been identified in content. As a member of club 300, company XYZ is allowed the services of incentive awards department 370 to offer incentive 370 to cookbook author 351.

Cookbook author 351 is part of content provider community 350, which comprises a variety of other content providers such as content provider 352, 354, 356, and 358. Content provider (352, 354, 356, 358) can be an author of a similar cookbook or author of various other topics such as automotive repair, art appreciation, or plate tectonics. For the sake of the present example and in accordance with an embodiment of the present invention, cookbook author 351 is interested in publishing only a dozen cookbooks for family members. Incentive awards department determines that an appropriate incentive 370 to present to cookbook author 351 is assistance from printing department 372 with printing fees. In turn for accepting incentive 370, cookbook author 351 grants privileges 380 to company XYZ to use her picture of her dashing XYZ classic paprika on her lasagna in XYZ's website.

In accordance with an embodiment of the present invention and the present example, club 300 has enabled cookbook author 351 to print her cookbook at a lower price and afford to print more cookbooks to give to friends and neighbors. Company XYZ 325 has been enabled by club 300 to gain broader exposure of their XYZ classic spice collection through additional copies of cookbook author 351's cookbook as well as use of a picture of cookbook author 351 using XYZ classic spice on their website. For a minimal cost to Company XYZ, their classic spice collection has gained authentic, unsolicited, and unaltered endorsement of their classic spice collection.

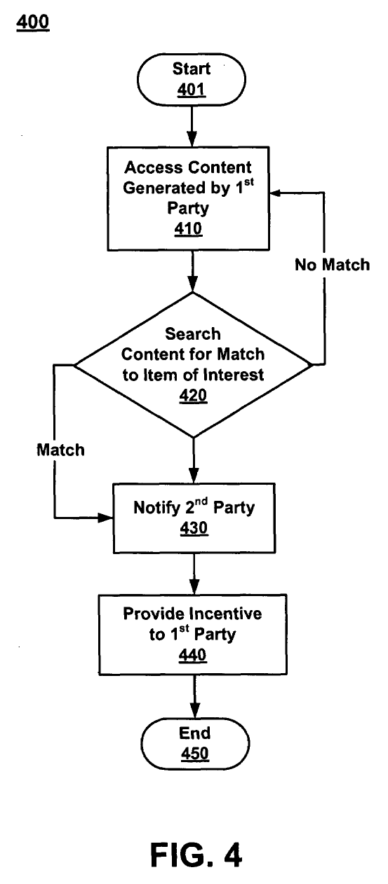

FIG. 4 is a flow chart illustrating a process 400 for providing an incentive for including an item in content, in accordance with an embodiment of the present invention. In one embodiment, process 400 is carried out by processors and electrical components under the control of computer readable and computer executable instructions. The computer readable and computer executable instructions reside, for example, in data storage features such as computer usable volatile and non-volatile memory. However, the computer readable and computer executable instructions may reside in any type of computer readable medium. Although specific components are disclosed in process 400, such components are exemplary. That is, the embodiments of the present invention are well suited to performing various other components or variations of the components recited in FIG. 4. Within the present embodiment, it should be appreciated that the components of process 400 may be performed by software, by hardware, by an assembly mechanism, through human interaction, or by any combination of software, hardware, assembly mechanism, and human interaction.

Process 400 will be described with reference to elements shown in FIGS. 1.

In one embodiment, as shown at 401 of process 400, system 200 (FIG. 1) is introduced into a suitable environment. A suitable environment is one wherein at least one first party provider 250 is generating content 240, and wherein second party 220 possesses at least one item 230 of interest.

In 410 of process 400, content 240 is accessed from first party provider 250 by second party 220. Accessing can be of a nature wherein a data base is accessed such as a digitized data base used by a first party generator for ordering printed content. Accessing can also comprise logging into a website where information has been compiled and/or generated by a first party.

In 420 of process 400, content 240 is searched for an item 230 of interest from second party 220. Searching can be of a nature wherein a data base of content such as a data base used for printing text and/or image data is searched for a match to at least one item 230 of interest. Searching can also comprise searching the Internet for information compiled and/or generated by a first party.

In accordance with another embodiment of the present invention, 420 of process 400 also comprises an evaluation of value to second party 220 of the match to the item of interest. The validity of the matched item of interest within content 240 is also evaluated. Item 230 of interest can be a product name, an organizational name, or a brand name associated with second party 220. The validity of the matched item of interest is validated to prevent the possibility of gaming and other fraudulent activity that might attempt to subvert the purpose of process 400.

In 430 of process 400, second party 220 is notified in response to identifying a match to item 230 of interest within content 240.

In 440 of process 400, second party 220 is provided a mechanism to provide an incentive to first party provider 250 for including item 230 in the content that first party provider 250 has generated. The incentive provided by second party 220 can have various forms. One such form can be remuneration, which in itself can have various forms such as, a discount for a service such as printing content 240, credits redeemable for the purchase of item 230, or royalties paid to first party provider 250 for the use of content 240. Other examples of possible incentives provided by second party 220 to first party provider 250 are: a new or broader venue for content 240, advertisement for first party provider 250 and/or content 240.

In 450 of process 400 is complete and an incentive for including item 230 by first party provider 250 in content 240 is accomplished. The completion of process 400 has given awareness to first party provider 250 of a broader interest in their content 240. Upon completion of process 400 an incentive has been given to first party provider 250 to disseminate item 230 in content 240.

The present invention, in the various presented embodiments allows for providing an incentive to a first party generator of content to include an item of interest of a second party in the first party generator's content. In so doing, the second party who has identified such an item of interest receives broader awareness of the item of interest with a reinforced sense of legitimacy and credulity having been recognized and documented by an unsolicited first party generator of the content. The first party generator is encouraged and motivated by the incentive provided by the second party to continue and possibly augment the use of the item of interest in their content.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for providing an incentive for including an item in content, said method comprising:
accessing said content, wherein said content is received from a first party;
searching said content for at least one said item identified by a second party;
notifying said second party in response to identifying said item; and
providing a mechanism for said second party to provide said first party with an incentive for including said item in said content.

2. The method of claim 1 wherein said content comprises textual data.

3. The method of claim 1 wherein said content comprises image data.

4. The method of claim 1 wherein said item comprises a product name.

5. The method of claim 1 wherein said item comprises an organizational name of said second party.

6. The method of claim 1 wherein said searching comprises:
evaluating said item for value to said second party; and
evaluating validity of said item within said content.

7. The method of Claim i wherein said incentive comprises remuneration.

8. The method of claim 1 wherein said incentive comprises a discount on a service.

9. A computer-readable memory containing executable instructions wherein said instructions when executed effect a method for providing an incentive for including an item in content, said method comprising:
accessing said content, wherein said content is created by a first party;
searching said content for at least one said item identified by a second party;
notifying said second party in response to identifying said item; and
providing a mechanism for said second party to provide said first party with an incentive for including said item in said content.

10. The computer readable memory as described in claim 9 wherein said method further comprises:
evaluating said item for value to said second party.

11. The computer readable memory as described in claim 9 wherein said method further comprises:
evaluating validity of said item within said content.

12. The computer readable memory as described in claim 9 wherein said incentive comprises remuneration.

13. The computer readable memory as described in claim 9 wherein said incentive comprises a discount on a service.

14. An incentive system comprising:
a search module for searching content received from a first party for at least one item identified by a second party;
a notification module for notifying said second party upon identification of said item; and
an incentive module for said second party to provide said first party with an incentive for including said item in said content.

15. The system of claim 14 wherein said content comprises textual data.

16. The system of claim 14 wherein said content comprises image data.

17. The system of claim 14 wherein said item comprises a product name.

18. The system of claim 14 wherein said search module is operable to evaluate said item for value to said second party and to evaluate validity of said item within said content.

19. The system of claim 14 wherein said search module is operable to evaluate validity of said first party.

20. The system of claim 14 wherein said incentive comprises remuneration to said first party.
